(19) United States
(12) Patent Application Publication
(10) Pub. No.: US 2001/0045467 A1
(43) Pub. Date: Nov. 29, 2001

(54) PORTABLE SMART CARD READER CAPABLE OF BEING USED EVEN WHEN STORED IN A HOLDER

(76) Inventor: ALEXANDRE MANTHE, AIX-EN-PROVENCE (FR)

Correspondence Address: ROLAND PLOTTEL, ROCKEFELLER CENTER STATION, PO BOX 293, NEW YORK, NY, 10185

(21) Appl. No.: 09/077,760

(22) PCT Filed: Dec. 10, 1996
(86) PCT No.: PCT/FR96/01963

§ 371 Date: None

(30) Foreign Application Priority Data
Dec. 11, 1995 (FR) 95/04853

(51) Int. Cl. G06K 7/00

(52) U.S. Cl. 235/486

(57) ABSTRACT

The invention relates to a portable chip card reader (1). This reader is designed so that it can operate even when it is stored. For this purpose it comprises, on one of its faces, an attachment means (4) to enable it to be fixed to the wall of a card holder compartment whilst leaving the card insertion slot (3) free. This attachment system allows simple handling of the reader under all circumstances. The chip card can be inserted either perpendicular or parallel to the direction in which information is displayed on a display device of the reader (1).

The invention relates to a portable chip card reader. Portable chip card readers are notably very useful for reading information contained in electronic substitutes for cash for example.

Such chip card readers are intended to be used at any time, in a shop, in the street or in the car. Consequently, to allow effective use whatever the place and/or time, it is necessary for them to be able to be handled simply and rapidly.

At the present time there exist portable chip card readers which are produced to the same size as chip cards and which have a reduced thickness, around a few millimeters. Such readers are sufficiently small to be able to be inserted into a card holder compartment.

In general terms, known readers do not have any means of fixing to a support. In particular, the applicant has discovered that both inserting and removing a reader into and from a card holder compartment is not easy to do. This is because, since the card reader is approximately two to four times thicker than a chip card, it is necessary to move the wall of the compartment of a card holder as far away as possible and exert a relatively high pressure on the reader in order to be able to insert it into a compartment.

In addition, storing the reader in a card holder compartment gives rise to a few drawbacks of a practical nature during use. This is because, in order to be able to read information contained in a chip card, it is necessary first of all to remove the card from the card holder, then to extract the reader from its compartment, and finally it is necessary to insert the card into the reader whilst keeping the card holder in the hand or close by. It is clear that the user must demonstrate great dexterity in order to be able to hold the reader, card and card holder all at the same time and then to insert the card into the reader. Manipulation is not easy.

The present invention makes it possible to simultaneously resolve these problems of storage and availability, and consequently to improve the conditions of use of the reader. It proposes in fact a portable chip card reader intended to be stored in a card holder, or attached to a support, principally characterised in that it comprises, on one of its faces, an attachment means in order to enable it to be fixed to a support, notably to the wall of a compartment of the card holder whilst leaving the insertion slot free.

By virtue of this attachment means, it is possible to use the reader without having to remove it from the card holder. Thus it suffices to hold only the card and the card holder. Handling the reader is consequently made easier and a rapid reading of the content of a card in all circumstances is made possible.

The attachment means must afford a good grip to provide effective holding of the reader notably at the time of insertion of the chip card, which then has a tendency to exert a slight thrust on the reader. However, if the attachment means does not provide a good hold, the reader may move under the action of the thrust. In order to prevent this it is necessary to firmly hold both the reader, on the opposite side to the direction of insertion of the card, and the card holder.

Consequently, according to another characteristic of the invention, the attachment means is produced so that it affords a rigid holding of the reader, in order to prevent the latter from moving when a chip card is inserted. Thus the attachment means has at least one tongue which can for example be in the form of a triangle or a rectangle to afford effective holding. When the attachment means has two tongues, these are preferably rectangular and independent.

The shape of the attachment means ensures the holding of the reader, and there is then no longer any need to hold the reader when the card is inserted, it merely suffices to hold the card holder.

According to another aspect of the invention, it has been realised that it is not practical to attach, to the wall of a card holder compartment, a reader whose size blocks more than one compartment in the card holder.

This is because, in present-day society, numerous services offer the use of chip cards so that a relatively large number of consumers are led to use more than half a dozen cards.

Consequently, according to another object of the invention, the reader, which also includes a display device, has dimensions enabling the card to be inserted either perpendicular to the direction in which the information is displayed on the display device, or parallel to this direction.

Other characteristics and advantages of the invention will emerge from a reading of the description given by way of illustrative and non-limitative example with reference to the accompanying drawings which depict:

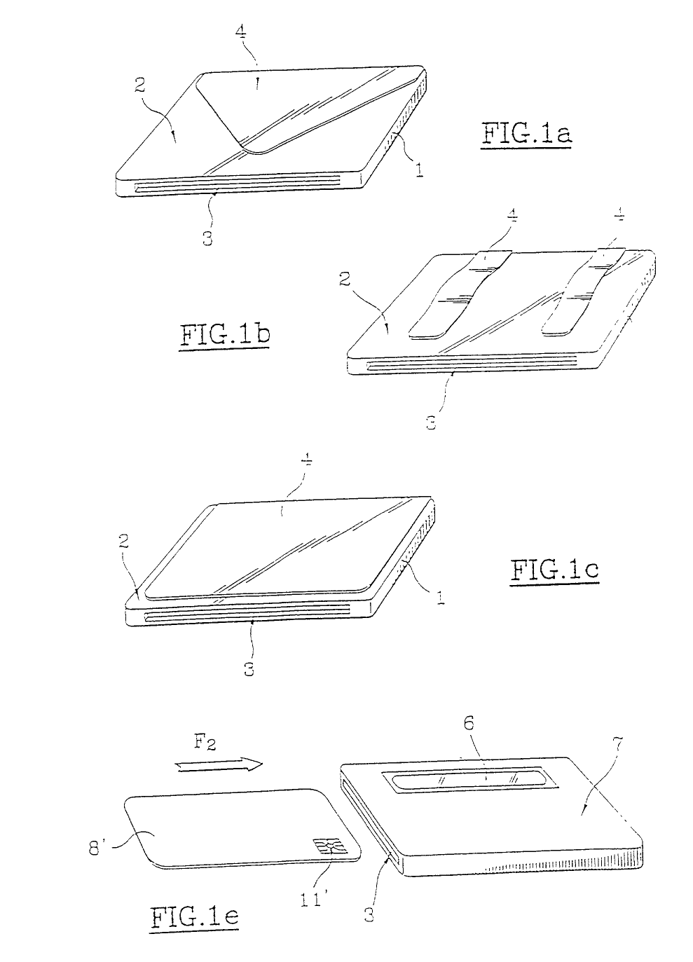

FIGS. 1a, 1b and 1c depict three versions of the rear face of a reader according to the invention,

FIGS. 1d and 1e, the front face of the reader of FIGS. 1a, 1b and 1c,

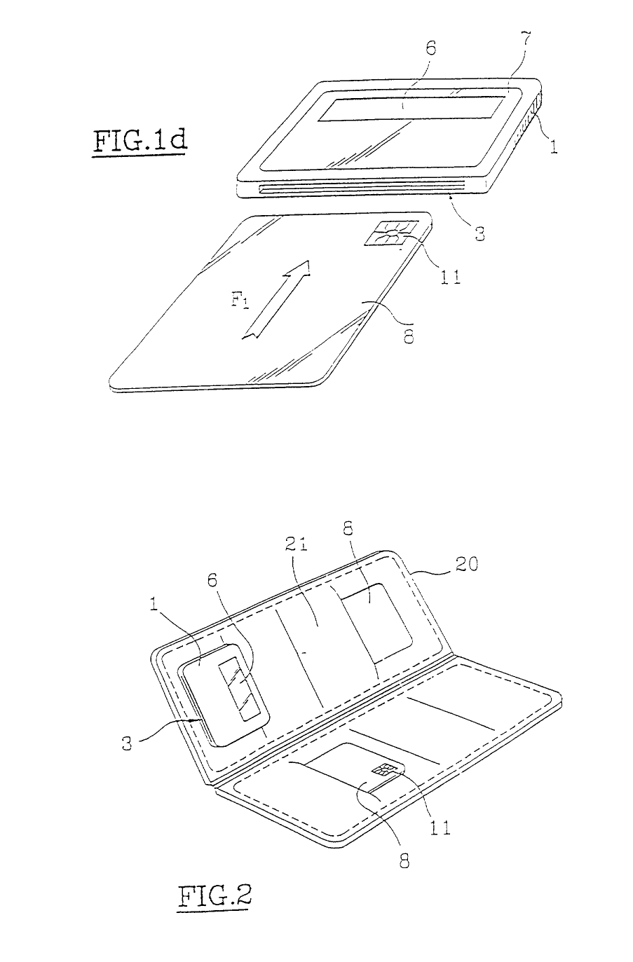

FIG. 2, the reader of FIG. 1 attached to a compartment of a card holder,

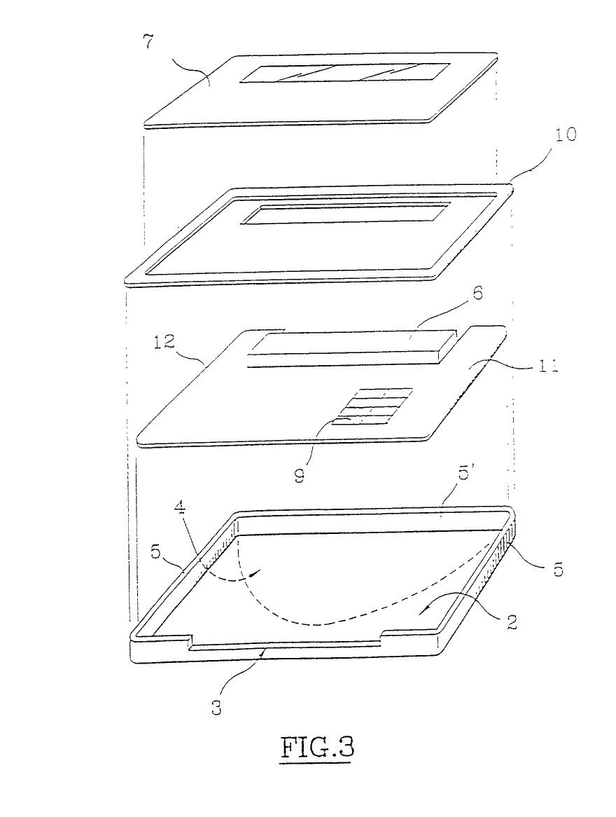

FIG. 3, an exploded view of the reader of FIG. 1.

A portable chip card reader produced according to the present invention is designated by the general reference 1 in FIGS. 1a, 1b, 1c, 1d and 1e. This reader comprises, on one of its faces, for example on its rear face 2, an attachment means 4 designed to slide in a card holder compartment or, in general terms, to be attached to a flat support. This attachment means 4 is for example made from plastic and molded with the rear face 2 of the reader. Its thickness is preferably less than or equal to that of a chip card, so that it can easily be inserted into a card holder compartment.

Advantageously, the attachment means 4 has at least one semi-rigid tongue affording rigid holding of the reader on a card holder compartment, and having different shapes. Thus the attachment means 4 has a tongue in the shape of a triangle, as depicted in FIG. 1a, or in the shape of a rectangle as depicted in FIG. 1c. According to another variant embodiment, the attachment means 4 has two independent rectangular tongues as depicted in FIG. 1b.

These different shapes enable the attachment means to afford a good grip on an attachment support and notably on the wall of a card holder compartment, and consequently afford rigid holding of the reader in a card holder.

The reader 1 also comprises an insertion slot 3 able to receive a chip card. Advantageously, the thickness and width of the slot 3 allow the insertion of a chip card whose format is described in ISO 7816-1 and ISO 7816-2.

FIG. 1d depicts the front face 7 of the reader 1. This front face has a display device 6, such as a liquid crystal screen for example, connected to electronics positioned between two plastic pieces constituting on the one hand the body of the reader and on the other hand the rear face of the reader. A chip card 8 is inserted into the slot 3 of the reader in the direction of the arrow F1, that is to say perpendicular to the direction in which the information is displayed on the display device 6.

In another embodiment of the reader according to the invention, as depicted in FIG. 1e, a chip card 8′ is inserted, into the lateral insertion slot 3′ of the reader, in the direction of the arrow F2, that is to say parallel to the direction in which the information is displayed on the display device 6.

The reader also has an internal connector with surface contacts slightly projecting, not visible in FIGS. 1d and 1e. This internal connector is designed and positioned so that it can come into contact with the different surface contacts 11, 11′ of the chip card 8, 8′.

FIG. 2 depicts the previously described reader 1, attached to the wall of a compartment 21 of a card holder 20. For this purpose, the attachment means 4 is housed in the compartment 21 of the card holder and keeps the reader firmly in place by gripping the wall of this compartment 21. In addition, by virtue of this attachment system, the screen 6 and insertion slot 3 of the reader 1 remain clear of the compartment 21, so that use of the reader 1 is made possible without having to remove it from the card holder. Thus it is possible to operate the reader under any circumstances. For this purpose, it suffices to remove a chip card from the card holder 20 and to insert it into the slot 3 of the reader held firmly on the wall of a compartment 21 of the card holder 20.

In general, portable chip card readers are produced in the conventional format of chip cards. However, in the case of the present invention, it has been realised that attaching such readers to a compartment 21 of a card holder 20 has a drawback of a practical nature since an entire side, or almost so, of the card holder 20 is blocked by the reader, which then covers several compartments.

In fact, as described previously, more and more services are currently offering the use of chip cards. Because of this, a relatively large number of consumers are led to possess more than half a dozen cards.

In order to avoid blocking part of the card holder 20, it has therefore become necessary to produce a reader having a smaller format. Thus the length of the reader must be less than or equal to the length of a card holder compartment 21 but at least slightly greater than the width of a chip card. Preferably the length of the reader is greater than the width of a chip card so as to be able to guide a chip card laterally at the time of insertion. This is depicted in FIGS. 1d and 1e. Likewise, the width of the reader is less than or equal to that of a compartment 21 of a card holder 20.

Thus the dimensions of the reader 1 are such that it obscures only a single chip card compartment 21 when it is attached in a card holder 20.

In addition, where provision is made for inserting a chip card parallel to the direction in which the information is displayed on the display device 6, the width of the reader must necessarily be at least slightly greater than that of the chip card 8′.

FIG. 3 depicts the reader 1 in exploded form. The reader has four parts: the rear face 2, the body 10, the front face 7 and an electronic assembly 12. The attachment means 4, produced on the back of the rear face 2, is depicted in dotted lines.

In addition, the rear face 2 has edges 5 and 5′ corresponding respectively to the lateral guides and to the longitudinal edge of the reader. In this figure, two lateral guides 5 are depicted so that, in this case, only insertion perpendicular to the direction in which the information is displayed on the display device 6 is possible.

The electronic assembly 12 of the reader 1 has a display 6, an electronic card 11 and an internal connector 9 with surface contacts slightly projecting, intended to come into contact with the surface contacts 11, 11′ of the chip card 8, 8′.

1. Portable chip card reader 1, intended to be stored in a card holder, characterised in that it comprises, on one of its faces, an attachment means (4) to enable it to be fixed to a support, notably to the wall of a compartment of the card holder whilst leaving the card insertion slot (3) free.

2. Reader according to claim 1, characterised in that the attachment means (4) includes at least one semi-rigid tongue.

3. Reader according to one of claims 1 to 2, characterised in that the attachment means (4) includes a single tongue in the shape of a triangle or rectangle.

4. Reader according to one of claims 1 to 2, characterised in that the attachment means (4) includes two independent tongues of rectangular shape.

5. Reader according to one of claims 1 to 4, characterised in that its dimensions are such that it obscures only one chip card compartment when it is attached to a card holder.

6. Reader according to one of claims 1 to 5, having a display device (6), characterised in that the chip card (8) is inserted perpendicular to the direction in which the information is displayed on the display device (6).

7. Reader according to one of claims 1 to 5, having a display device (6), characterised in that the chip card (8′) is inserted parallel to the direction in which the information is displayed on the display device (6).

8. Reader according to claim 7, characterised in that its width must also be at least slightly greater than that of a chip card (8′).
